(19) United States
(12) Patent Application Publication
(10) Pub. No.: US 2024/0267744 A1
(43) Pub. Date: Aug. 8, 2024

(54) SPECTRUM ACCESS ARBITER ENTITY FOR SHARING SPECTRUM RESOURCES

(71) Applicant: QUALCOMM Incorporated, San Diego, CA (US)

(72) Inventors: Aleksandar DAMNJANOVIC, Del Mar, CA (US); Abhishek Saurabh SACHIDANAND SINHA, San Diego, CA (US); Michael Francis GARYANTES, Bradley Beach, NJ (US)

(21) Appl. No.: 18/510,939

(22) Filed: Nov. 16, 2023

Related U.S. Application Data
(60) Provisional application No. 63/482,942, filed on Feb. 2, 2023.

(51) Int. Cl. H04W 16/14; H04W 12/0471; H04W 12/06; H04W 72/1263

(52) U.S. Cl. CPC H04W 16/14; H04W 12/0471; H04W 12/06; H04W 72/1263

(57) ABSTRACT

Various aspects of the present disclosure generally relate to wireless communication. In some aspects, a network node may transmit, to an open radio access network distributed unit (O-DU) associated with the network node, a grant that permits use of a shared spectrum resource, the grant indicating a first cryptographic checksum for a given timeslot in which the shared spectrum resource is granted. The network node may receive, from the O-DU, a transmission that includes a second cryptographic checksum. The network node may transmit the transmission via the shared spectrum resource based at least in part on an authentication of the transmission, the authentication involving the grant being accepted by the open radio access network radio unit (O-RU) based at least in part on a verification that the second cryptographic checksum corresponds to the first cryptographic checksum. Numerous other aspects are described.

### CROSS-REFERENCE TO RELATED APPLICATION

This Patent Application claims priority to U.S. Provisional Patent Application No. 63/482,942, filed on Feb. 2, 2023, entitled “SPECTRUM ACCESS ARBITER ENTITY FOR SHARING SPECTRUM RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a spectrum access arbiter entity for sharing spectrum resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the features of the present disclosure can be understood in detail, a more particular description, briefly summarized below, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples associated with a spectrum access arbiter entity for sharing spectrum resources, in accordance with the present disclosure.

FIGS. 6A-6B are diagrams illustrating examples associated with a spectrum access arbiter entity for sharing spectrum resources, in accordance with the present disclosure.

FIGS. 7A-7B are diagrams illustrating examples associated with a spectrum access arbiter entity for sharing spectrum resources, in accordance with the present disclosure.

FIGS. 8A-8B are diagrams illustrating examples associated with a spectrum access arbiter entity for sharing spectrum resources, in accordance with the present disclosure.

FIG. 9 is a diagram illustrating an example process associated with a spectrum access arbiter entity for sharing spectrum resources, in accordance with the present disclosure.

FIG. 10 is a diagram of an example apparatus for wireless communication, in accordance with the present disclosure.

### SUMMARY

In some implementations, an apparatus for wireless communication at a network node includes a memory and one or more processors, coupled to the memory, configured to: transmit, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted; receive, by an open radio access network radio unit (O-RU) associated with the network node and from the O-DU, a transmission that includes a second cryptographic checksum, the transmission being received based at least in part on the grant; and transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

In some implementations, a method of wireless communication performed by a network node includes transmitting, by a spectrum access arbiter entity associated with the network node and to an O-DU associated with the network node, a grant that permits use of a shared spectrum resource, the grant being associated with a reservation of the shared spectrum resource, and the grant indicating a first cryptographic checksum for a given timeslot in which the shared spectrum resource is granted; receiving, by an O-RU associated with the network node and from the O-DU, a transmission that includes a second cryptographic checksum, the transmission being received based at least in part on the grant; and transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

In some implementations, a non-transitory computer-readable medium storing a set of instructions for wireless communication includes one or more instructions that, when executed by one or more processors of a network node, cause the network node to: transmit, by a spectrum access arbiter entity associated with the network node and to an O-DU associated with the network node, a grant that permits use of a shared spectrum resource, the grant being associated with a reservation of the shared spectrum resource, and the grant indicating a first cryptographic checksum for a given timeslot in which the shared spectrum resource is granted; receive, by an O-RU associated with the network node and from the O-DU, a transmission that includes a second cryptographic checksum, the transmission being received based at least in part on the grant; and transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

In some implementations, an apparatus for wireless communication includes means for transmitting, by a spectrum access arbiter entity associated with the apparatus and to an O-DU associated with the apparatus, a grant that permits use of a shared spectrum resource, the grant being associated with a reservation of the shared spectrum resource, and the grant indicating a first cryptographic checksum for a given timeslot in which the shared spectrum resource is granted; means for receiving, by an O-RU associated with the apparatus and from the O-DU, a transmission that includes a second cryptographic checksum, the transmission being received based at least in part on the grant; and means for transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

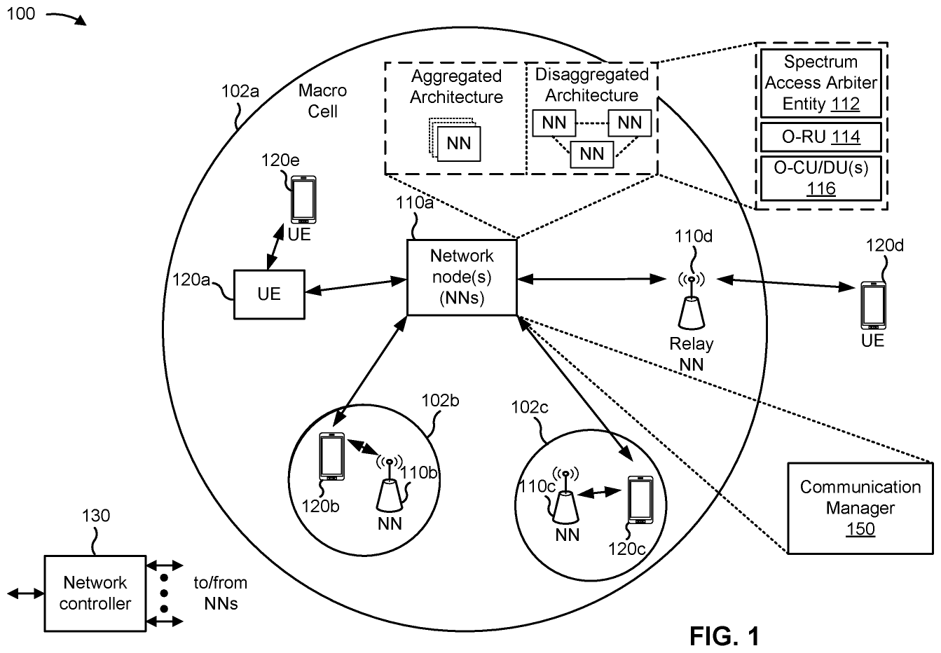

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., network node 110) may include a communication manager 150. As described in more detail elsewhere herein, the communication manager 150 may transmit, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted; receive, by an open radio access network radio unit (O-RU) associated with the network node and from the O-DU, a transmission that includes a second cryptographic checksum, the transmission being received based at least in part on the grant; and transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum. Additionally, or alternatively, the communication manager 150 may perform one or more other operations described herein.

As indicated above, FIG. 1 is provided as an example. Other examples may differ from what is described with regard to FIG. 1.

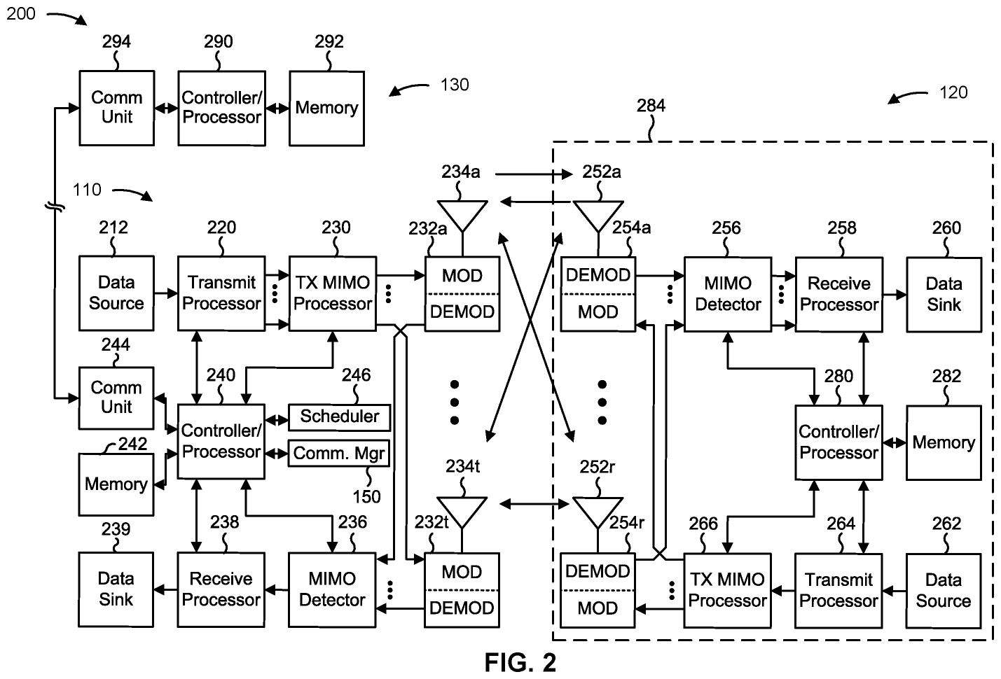

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

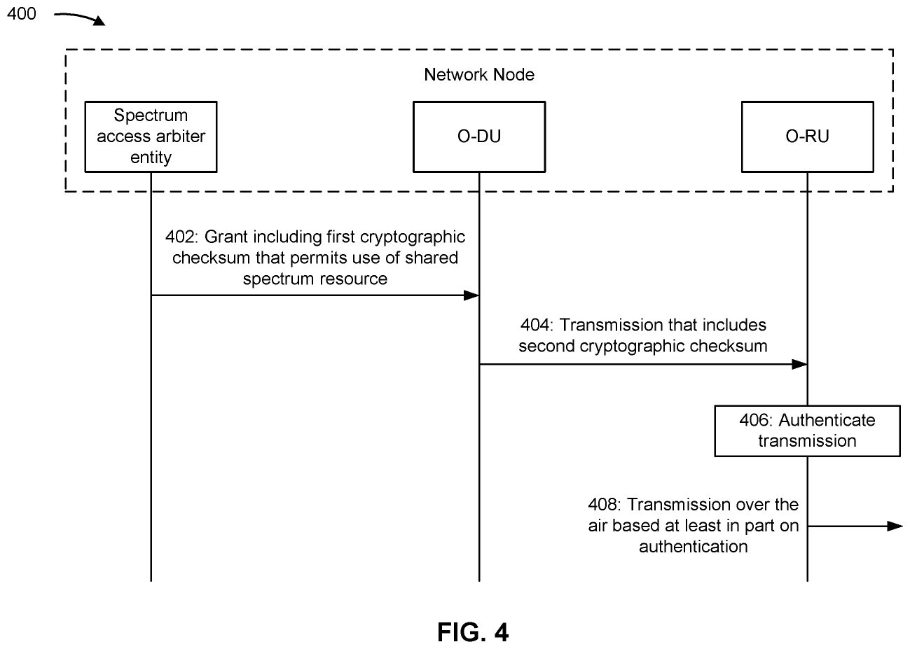

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-5, 6A, 6B, 7A, 7B, 8A, 8B, and 9-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-5, 6A, 6B, 7A, 7B, 8A, 8B, and 9-10).

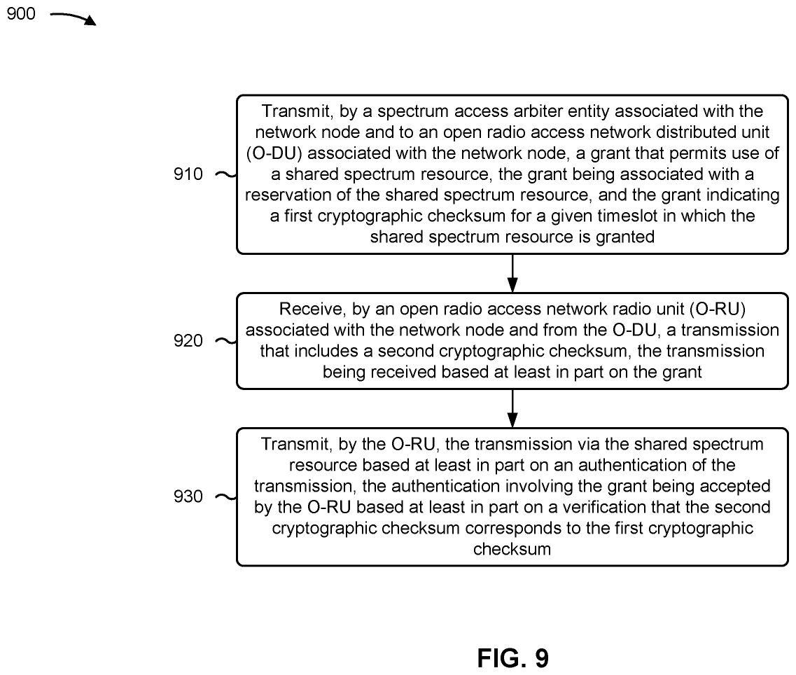

The controller/processor 240 of the network node 110, the controller/processor 280 of the UE 120, and/or any other component(s) of FIG. 2 may perform one or more techniques associated with a spectrum access arbiter entity for sharing spectrum resources, as described in more detail elsewhere herein. In some aspects, the spectrum access arbiter entity, the O-RU, and/or the O-DU described herein are the network node 110, are included in the network node 110, or include one or more components of network node 110 shown in FIG. 2. For example, the controller/processor 240 of the network node 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, a network node (e.g., network node 110) includes means for transmitting, by a spectrum access arbiter entity associated with the network node and to an O-DU associated with the network node, a grant that permits use of a shared spectrum resource, the grant being associated with a reservation of the shared spectrum resource, and the grant indicating a first cryptographic checksum for a given timeslot in which the shared spectrum resource is granted; means for receiving, by an O-RU associated with the network node and from the O-DU, a transmission that includes a second cryptographic checksum, the transmission being received based at least in part on the grant; and/or means for transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

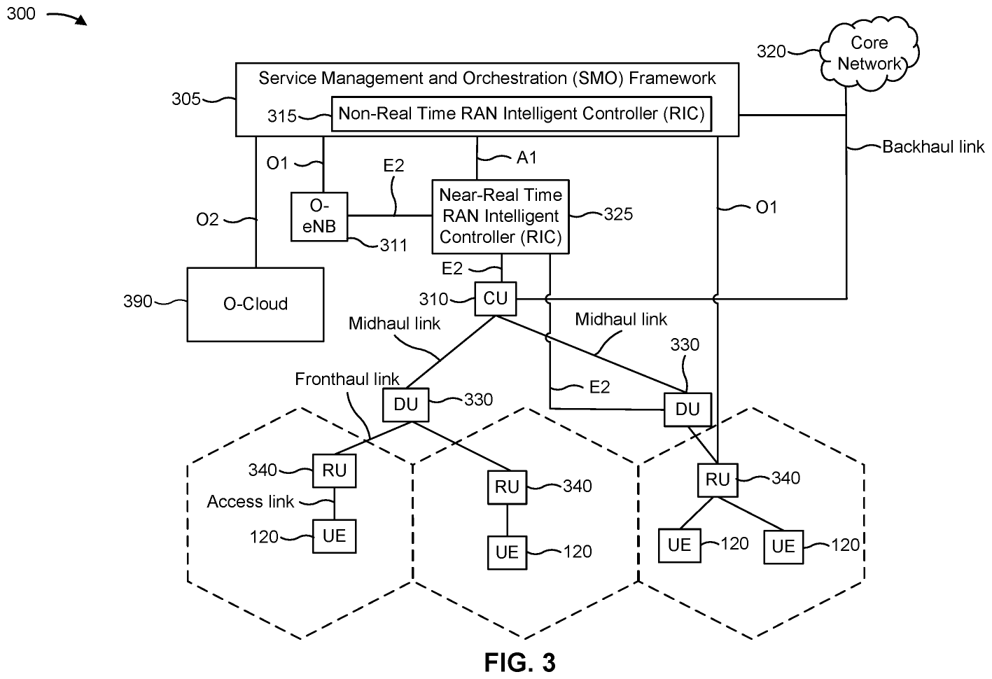

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Spectrum is critical for the success of wireless systems. Spectrum may be exclusively licensed by a mobile network operator (MNO). Exclusively licensed spectrum may be well-suited for terrestrial mobile networks, but bands with capacity and coverage tradeoffs appropriate for wide area coverage may be scarce. Unlicensed spectrum may be suitable for specialized use cases due to relatively low power limitations and an inability to fully control service quality. Shared spectrum may involve the sharing of spectrum in an O-RAN architecture. Shared spectrum may not suffer from drawbacks associated with the unlicensed spectrum.

Exclusively licensed spectrum may involve fragmenting spectrum resources. For example, first spectrum resources may be associated with a first MNO, and second spectrum resources may be associated with a second MNO. However, a user experience may be limited by available frequency resources. Resources assigned to one licensee may be fully utilized, while others of other licensees may be idle.

Spectrum sharing may offer great spectrum utilization and reduce the cost of spectrum, as compared to exclusively licensed spectrum. Spectrum sharing enables the controlled reuse of otherwise idle resources and may prevent uncontrollable interference. An MNO may reuse spectrum of other MNOs when the spectrum is not in use. Spectrum sharing may lead to reduced service time and/or higher throughput, as compared to exclusively licensed spectrum. With spectrum sharing, coordinated priority access licensing may be used instead of exclusive licensing. An O-RAN architecture may be utilized to facilitate coordinated use of resources. For example, a primary licensee may be able to access licensed frequency resources at any time, whereas a secondary licensee may be allowed to utilize idle primary licensee resources. The O-RAN architecture may enable differentiation between MNOs when the spectrum is shared among the MNOs.

With spectrum sharing, a conflict may occur when multiple O-DUs request the same resource (e.g., the same O-RU resource in a given timeslot) from an O-RU. The multiple O-DUs may negotiate with the O-RU, such that only one of the O-DUs is able to access that resource. Other O-DUs may not be granted access to that resource. The O-RU may function to arbitrate spectrum sharing decisions. However, the O-RU may not be configured to perform an authentication of subsequent transmissions received from one or more of the multiple O-DUs during the given timeslot. For example, the O-RU may be unable to detect when an O-DU which was not granted access to that resource attempts to transmit using that resource. Similarly, the O-RU may be unable to verify that an O-DU which was granted access to that resource is able to transmit using that resource. In other words, the O-RU may be limited when arbitrating such spectrum sharing decisions.

In various aspects of techniques and apparatuses described herein, an O-RU may transmit, via a spectrum access arbiter entity associated with the O-RU and to an O-DU, a grant that permits use of a shared spectrum resource. The grant may be associated with a reservation of the shared spectrum resource. The grant may indicate a first cryptographic checksum for a given timeslot in which the shared spectrum resource is granted. When granting shared spectrum resource use, the spectrum access arbiter entity may provide, to the O-DU, the first cryptographic checksum for the given timeslot during which the shared spectrum resource is granted. The O-RU may receive, from the O-DU and based at least in part on the grant, a transmission that includes a second cryptographic checksum. The O-RU may transmit the transmission, as received from the O-DU, over the air via the shared spectrum resource based at least in part on an authentication of the transmission. During the authentication, the O-RU may verify that the second cryptographic checksum corresponds to the first cryptographic checksum. During the authentication, the O-RU may accept the grant based at least in part on the second cryptographic checksum corresponding to the first cryptographic checksum. The O-RU and the spectrum access arbiter entity may share secret keys for the O-RU to be able to authenticate shared spectrum arbiter decisions. Depending on the authentication, the O-RU may verify the transmission, and then transmit the transmission on behalf of the O-DU.

In some aspects, the spectrum access arbiter entity may be employed for O-RU spectrum sharing. In O-RU spectrum sharing, an O-RU sharing framework may be leveraged to enable spectrum sharing. Spectrum sharing may be facilitated by the O-RU, which may be a shared O-RU among multiple O-DUs. The spectrum access arbiter entity may be co-located with the O-RU. The spectrum access arbiter entity may be non-co-located with the O-RU. In some cases, more than one spectrum access arbiter entity may be associated with each O-RU. The spectrum access arbiter entity may be co-located with a priority O-DU. Regardless of whether the spectrum access arbiter entity is co-located or non-co-located with the O-RU, a common protocol may be employed.

In some aspects, when the O-RU and the spectrum access arbiter entity are separate entities, and the spectrum access arbiter entity is responsible for granting shared spectrum resources, the O-RU may be able to use authentication to verify that transmissions received from O-DUs are in fact allowed by the spectrum access arbiter entity. By the O-RU and the spectrum access arbiter entity sharing secret keys, the O-RU may be able to authenticate transmissions received from the O-DU. Otherwise, the O-RU may be unaware of whether the O-DU sending the transmissions is in fact allowed to use the shared spectrum resources. As a result, spectrum sharing in an O-RAN architecture may be improved, thereby leading to reduced service time and/or higher throughput.

A disaggregated open RAN architecture may be associated with various deployment scenarios. One deployment scenario may involve MNOs owning O-RUs and spectrum. Each MNO may have priority use of the O-RU on the spectrum owned by the MNO, and MNOs may lease the spectrum and O-RU access to other MNOs. This feature may allow MNOs the possibility to monetize resources when resources are not used, but also the possibility to acquire additional resources in real time from other MNOs during peak demand. Another deployment scenario may involve MNOs owning spectrum, but all of the MNOs may share single physical O-RUs. Another deployment scenario may involve spectrum and a shared O-RU being owned by a third party. The shared O-RU may apply to deployment scenarios in which each MNO has its own dedicated network and the shared O-RU on a shared component carrier group. Another deployment scenario may involve the shared O-RU being owned by a non-public network owner where a utilized spectrum may be locally licensed or unlicensed. The shared O-RU spectrum sharing concept may also apply for deployment scenarios in which federal users have priority access and may preempt other MNOs to access the shared O-RU and/or certain portions of the spectrum.

FIG. 4 is a diagram illustrating an example 400 associated with a spectrum access arbiter entity for sharing spectrum resources, in accordance with the present disclosure. As shown in FIG. 4, example 400 includes communication between a spectrum access arbiter entity (e.g., spectrum access arbiter entity 112), an O-RU (e.g., O-RU 114), and multiple O-RAN CUs (O-CUs) and/or O-DUs (O-CU/DUs) (e.g., O-CU/DU 116). In some aspects, the spectrum access arbiter entity, the O-RU, and the O-DU may be included in a wireless network, such as wireless network 100.

As shown by reference number 402, the spectrum access arbiter entity may transmit, to the O-DU, a grant that permits use of a shared spectrum resource. The shared spectrum resource may be associated with the O-RU. The grant may be associated with a reservation of the shared spectrum resource. The grant may be indicated in a reservation response, which may be in response to a reservation request from the O-DU, where the reservation request may include a request to use the shared spectrum resource. The spectrum access arbiter entity may transmit the grant to the O-DU based at least in part on a conflict resulting from multiple O-DUs requesting the same resources.

In some aspects, the grant may indicate a first cryptographic checksum for a given timeslot in which the shared spectrum resource is granted. The first cryptographic checksum may be based at least in part on a secret key exchange between the O-RU and the spectrum access arbiter entity associated with the O-RU. In other words, based at least in part on the secret key exchange, both the spectrum access arbiter entity and the O-RU may be aware of the first cryptographic key.

In some aspects, the spectrum access arbiter entity may be co-located with the O-RU. Alternatively, the spectrum access arbiter entity may be non-co-located with the O-RU. The spectrum access arbiter entity may be associated with O-RU spectrum sharing. The O-RU may be a shared O-RU among multiple MNOs. In other words, the multiple MNOs may use the shared O-RUs for transmissions/receptions of data. The spectrum access arbiter entity may be one of a plurality of spectrum access arbiter entities associated with the O-RU, where each spectrum access arbiter entity may be associated with a subset of resources (e.g., a particular set of frequency resources) of the O-RU.

As shown by reference number 404, the O-DU may transmit, to the O-RU, a transmission that includes a second cryptographic checksum. The O-DU may transmit the transmission based at least in part on the grant, which the O-DU may receive from the spectrum access arbiter entity. The transmission may be associated with IQ samples. The second cryptographic checksum may be the same as the first cryptographic checksum, or the second cryptographic checksum may be different from the first cryptographic checksum. The transmission may be intended for a recipient (e.g., a UE or another network node), and the second cryptographic checksum may be included along with the transmission.

As shown by reference number 406, the O-RU may authenticate the transmission received from the O-DU. Since the O-RU did not authorize the O-DU to use the shared spectrum resource, but rather the spectrum access arbiter entity granted the use of the shared spectrum resource, the O-RU may need to verify that the O-DU is in fact allowed to use the shared spectrum resource. The O-RU may verify that the O-RU is allowed to use the shared spectrum resource as part of the authentication. As part of the authentication, the O-RU may accept the grant based at least in part on a verification that the second cryptographic checksum corresponds to the first cryptographic checksum. In other words, the O-RU may check whether the second cryptographic checksum, as received in the transmission, corresponds to the first cryptographic checksum, which may be stored in the O-RU. When the first and second cryptographic checksums match, the O-RU may authenticate the transmission.

Alternatively, when the first cryptographic checksum does not match with the second cryptographic checksum, the O-RU may not authenticate the transmission received from the O-DU. In this case, the O-RU may determine that the second cryptographic checksum, as received in the transmission, does not correspond to the first cryptographic checksum, which may be stored in the O-RU. The first cryptographic checksum not matching the second cryptographic checksum may imply that the O-DU is not allowed to use the shared spectrum resource.

As shown by reference number 408, the O-RU may transmit the transmission for the O-DU over the air to the recipient based at least in part on the authentication of the transmission. The O-RU may transmit the transmission on behalf of the O-DU after verifying that the O-DU is permitted to use the shared spectrum resource for the transmission. Alternatively, when the transmission is not authenticated (e.g., due to the first cryptographic checksum not matching the second cryptographic checksum), the O-RU may not transmit the transmission for the O-DU over the air to the recipient. In this case, the O-RU may send an indication to the O-DU, where the indication may notify the O-DU that the transmission was not allowed.

As indicated above, FIG. 4 is provided as an example. Other examples may differ from what is described with regard to FIG. 4.

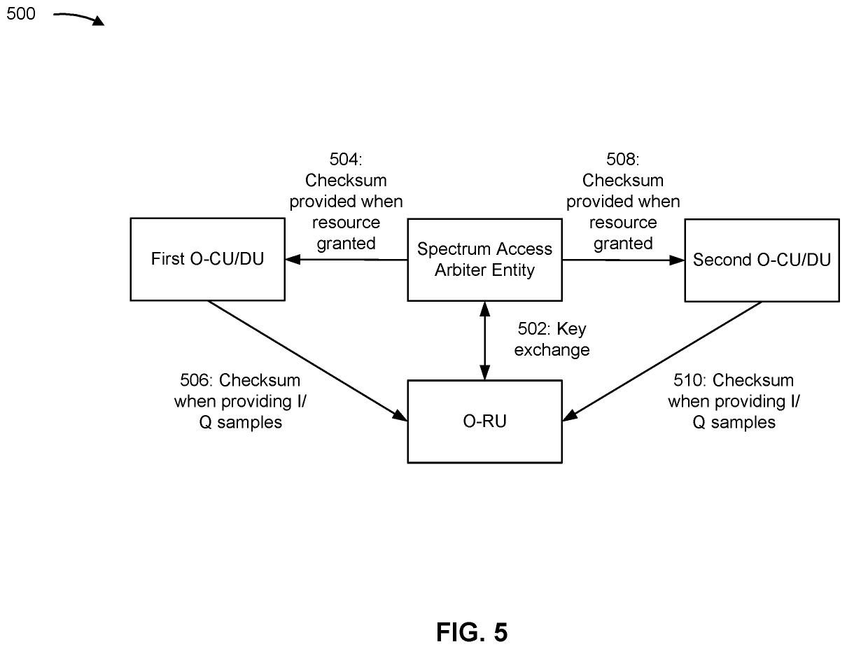

FIG. 5 is a diagram illustrating an example 500 associated with a spectrum access arbiter entity for sharing spectrum resources, in accordance with the present disclosure. As shown in FIG. 5, example 500 includes communication between a spectrum access arbiter entity (e.g., spectrum access arbiter entity 112), an O-RU (e.g., O-RU 114), and multiple O-CUs/DUs (e.g., O-CU/DU 116). In some aspects, the spectrum access arbiter entity, the O-RU, and the multiple O-CUs/DUs may be included in a wireless network, such as wireless network 100.

As shown by reference number 502, a spectrum access arbiter entity and an O-RU may perform a secret key exchange. Secret keys may be shared between the spectrum access arbiter entity and the O-RU. The spectrum access arbiter entity may be co-located with the O-RU, or alternatively, the spectrum access arbiter entity may be non-co-located with the O-RU. The O-RU may be a shared O-RU, which may be shared between multiple O-CUs/DUs, such as a first O-CU/DU and a second O-CU/DU.

As shown by reference number 504, the spectrum access arbiter entity may provide, to the first O-CU/DU, a cryptographic checksum when a resource is granted to the first O-CU/DU. The resource may be an O-RU resource. The spectrum access arbiter entity may provide the cryptographic checksum when granting a reservation request to use the resource. As shown by reference number 506, the first O-CU/DU may include the cryptographic checksum when providing a transmission (e.g., in-phase and quadrature (IQ) samples) to the O-RU. The O-RU may compare the cryptographic checksum received from the first O-CU/DU with a stored cryptographic checksum, which may be known based at least in part on the secret key exchange, and based at least in part on the comparison, the O-RU may authenticate the transmission and send the transmission over the air. For example, the O-RU may authenticate the transmission based at least in part on the cryptographic checksums matching with each other. Cryptographic checksums that match may include cryptographic checksums that are the same, or may include cryptographic checksums that are within a threshold or tolerance of each other.

As shown by reference number 508, the spectrum access arbiter entity may provide, to the second O-CU/DU, a cryptographic checksum when a resource is granted to the second O-CU/DU. The resource may be an O-RU resource. The spectrum access arbiter entity may provide the cryptographic checksum when granting a reservation request to use the resource. As shown by reference number 510, the second O-CU/DU may include the cryptographic checksum when providing a transmission (e.g., IQ samples) to the O-RU. The O-RU may compare the cryptographic checksum received from the second O-CU/DU with a stored cryptographic checksum, which may be known based at least in part on the secret key exchange, and based at least in part on the result of the comparison, the O-RU may authenticate the transmission and send the transmission over the air.

In some aspects, the O-RU and the spectrum access arbiter entity, which may be associated with the O-RU, may share the secret keys, which may allow the O-RU to be able to authenticate spectrum arbiter decisions. When granting a shared spectrum resource use to a particular O-CU/DU, the spectrum access arbiter entity may provide, to that particular O-CU/DU, the cryptographic checksum for a given timeslot in which the shared spectrum resource is granted. As a result, the cryptographic checksum may be later verified by the O-RU when the O-CU/DU attempts to use the shared spectrum resource.

In some aspects, the first O-CU/DU may be a priority O-CU/DU, and the second O-CU/DU may be a secondary O-CU/DU. The priority O-CU/DU may also have a secret key for its prioritized shared spectrum resources when preemption is allowed. In other words, since the prioritized O-CU/DU has a higher priority as compared to the secondary O-CU/DU, the prioritized O-CU/DU may have priority to shared spectrum resources over the secondary O-CU/DU.

As indicated above, FIG. 5 is provided as an example. Other examples may differ from what is described with regard to FIG. 5.

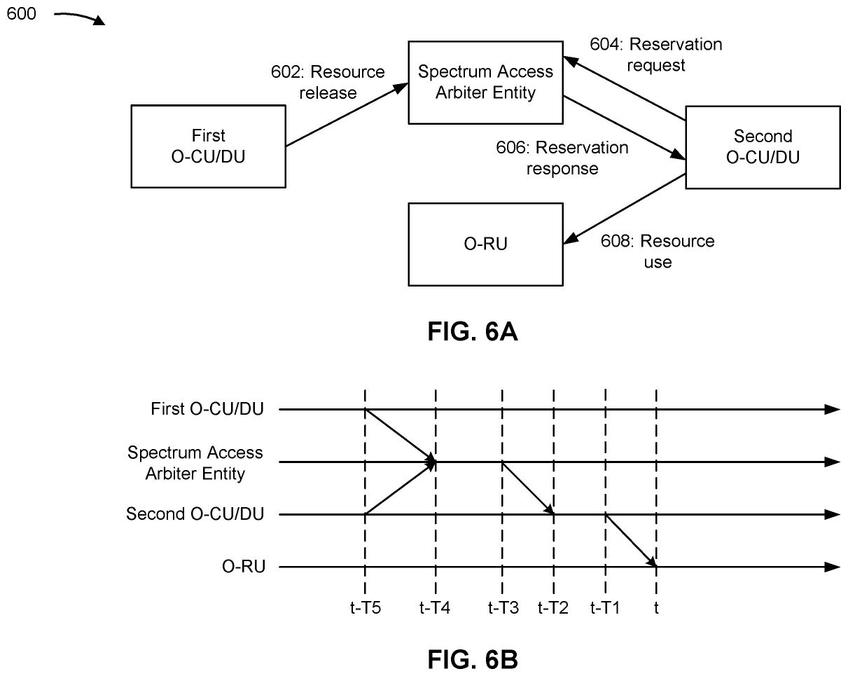

FIGS. 6A-6B are diagrams illustrating an example 600 associated with a spectrum access arbiter entity for sharing spectrum resources, in accordance with the present disclosure. As shown in FIGS. 6A-6B, example 600 includes communication between a spectrum access arbiter entity (e.g., spectrum access arbiter entity 112), an O-RU (e.g., O-RU 114), and multiple O-CUs/DUs (e.g., O-CU/DU 116), such as a first O-CU/DU and a second O-CU/DU. In some aspects, the spectrum access arbiter entity, the O-RU, and the multiple O-CUs/DUs may be included in a wireless network, such as wireless network 100.

As shown in FIG. 6A, and by reference number 602, the first O-CU/DU may transmit, to the spectrum access arbiter entity, an indication of a resource release. The first O-CU/DU may initially be using resources associated with the O-RU, but may indicate that the resources may be released. The O-RU may be a shared O-RU, which may be shared among the multiple O-CUs/DUs. As shown by reference number 604, the second O-CU/DU may transmit, to the spectrum access arbiter entity, a reservation request. The reservation request may be to reserve resources associated with the O-RU. As shown by reference number 606, the spectrum access arbiter entity may transmit, to the second O-CU/DU and based at least in part on the reservation request, a reservation response. The reservation response may indicate a grant to use the resources associated with the O-RU. The reservation response may include a cryptographic checksum. As shown by reference number 608, the second O-CU/DU may transmit, to the O-RU, an indication of a resource use, which may indicate that the second O-CU/DU is using the resources associated with the O-RU. In some aspects, the second O-CU/DU may indicate a cryptographic checksum, which the O-RU may compare with the cryptographic checksum included in the reservation response, and based at least in part on a match between the cryptographic checksums, the O-RU may permit the second O-CU/DU to use the resources associated with the O-RU.

As shown in FIG. 6B, a time t−T5 (t minus T5) may be associated with the first O-CU/DU transmitting the indication of the resource release and the second O-CU/DU transmitting the reservation request. A time t−T4 may be associated with the spectrum access arbiter entity receiving the indication of the resource release and the reservation request from the first O-CU/DU and the second O-CU/DU, respectively. A time T5−T4 may be associated with an O-CU/DU to spectrum access arbiter entity delay. A time T4−T3 may be associated with a spectrum access arbiter entity processing delay. A time t−T3 may be associated with the spectrum access arbiter entity transmitting the reservation response to the second O-CU/DU. A time t−T2 may be associated with the second O-CU/DU receiving the reservation response from the spectrum access arbiter entity. A time T3−T2 may be associated with a spectrum access arbiter entity to O-CU/DU fronthaul delay. A time T2−T1 may be associated with an O-CU/DU processing and scheduling delay. A prescheduling may reduce this delay. A pipelining may be suitable for a priority user. A time t−T1 may be associated with the second O-CU/DU transmitting, to the O-RU, the indication of the resource use. A time T1 may be associated with an O-CU/DU to O-RU fronthaul delay. A time t may be associated with the O-RU receiving the indication of the resource use from the second O-CU/DU. Thus, an amount of time before the resource associated with the O-RU is able to be scheduled is T5.

As indicated above, FIG. 6A-6B is provided as an example. Other examples may differ from what is described with regard to FIG. 6A-6B.

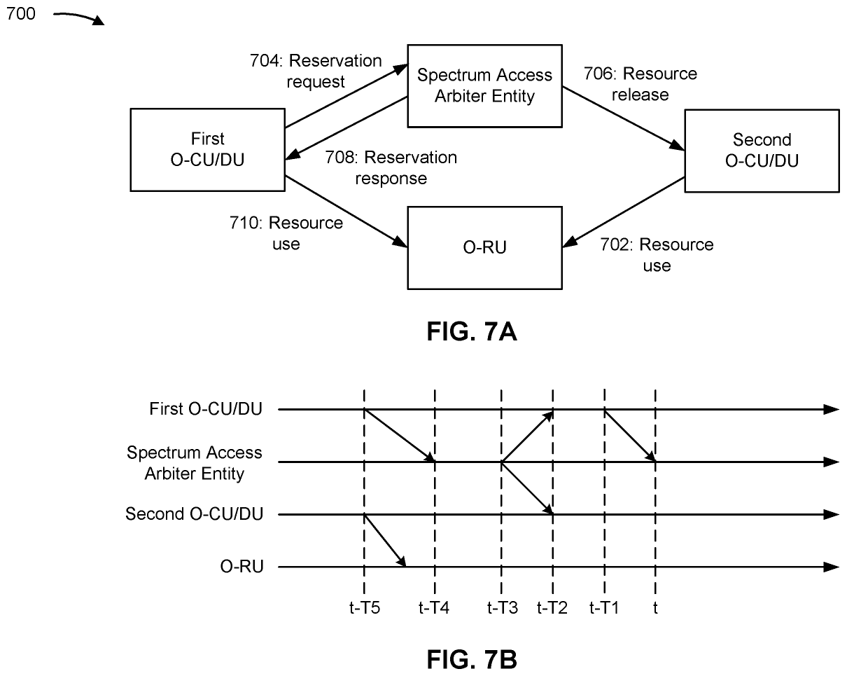

FIGS. 7A-7B are diagrams illustrating an example 700 associated with a spectrum access arbiter entity for sharing spectrum resources, in accordance with the present disclosure. As shown in FIGS. 7A-7B, example 700 includes communication between a spectrum access arbiter entity (e.g., spectrum access arbiter entity 112), an O-RU (e.g., O-RU 114), and multiple O-CUs/DUs (e.g., O-CU/DU 116), such as a first O-CU/DU and a second O-CU/DU. In some aspects, the spectrum access arbiter entity, the O-RU, and the multiple O-CUs/DUs may be included in a wireless network, such as wireless network 100.

As shown in FIG. 7A, and by reference number 702, the second O-CU/DU may transmit, to the O-RU, an indication of a resource use, which may indicate that the second O-CU/DU is using resources associated with the O-RU. The O-RU may be a shared O-RU, which may be shared among the multiple O-CUs/DUs. As shown by reference number 704, the first O-CU/DU may transmit, to the spectrum access arbiter entity, a reservation request. The reservation request may be to reserve resources associated with the O-RU. As shown by reference number 706, the spectrum access arbiter entity may transmit, to the second O-CU/DU, an indication of a resource release. The second O-CU/DU may initially be using resources associated with the O-RU, but the resources may be released due to the first O-CU/DU being a priority O-CU/DU and the second O-CU/DU being a secondary O-CU/DU. As shown by reference number 708, the spectrum access arbiter entity may transmit, to the first O-CU/DU, a reservation response. The reservation response may be in response to the reservation request. The reservation response may indicate a grant to use the resources associated with the O-RU. The reservation response may include a cryptographic checksum. As shown by reference number 710, the first O-CU/DU may transmit, to the O-RU, an indication of a resource use, which may indicate that the first O-CU/DU is using the resources associated with the O-RU. In some aspects, the first O-CU/DU may indicate a cryptographic checksum, which the O-RU may compare with the cryptographic checksum included in the reservation response, and based at least in part on a match between the cryptographic checksums, the O-RU may permit the first O-CU/DU to use the resources associated with the O-RU.

As shown in FIG. 7B, a time t−T5 may be associated with the second O-CU/DU transmitting the indication of the resource use and the first O-CU/DU transmitting the reservation request. A time t−T4 may be associated with the spectrum access arbiter entity receiving the reservation request from the first O-CU/DU. A time T5−T4 may be associated with an O-CU/DU to spectrum access arbiter entity delay. A time T4−T3 may be associated with a spectrum access arbiter entity processing delay. A time t−T3 may be associated with the spectrum access arbiter entity transmitting the indication of the resource release to the second O-CU/DU. The time t−T3 may also be associated with the spectrum access arbiter entity transmitting the reservation response to the first O-CU/DU. A time t−T2 may be associated with the second O-CU/DU receiving the indication of the resource release from the spectrum access arbiter entity. The time t−T2 may also be associated with the first O-CU/DU receiving the reservation response from the spectrum access arbiter entity. A time T3−T2 may be associated with a spectrum access arbiter entity to O-CU/DU fronthaul delay. A time T2−T1 may be associated with an O-CU/DU processing and scheduling delay. A prescheduling may reduce this delay. A pipelining may be suitable for a priority user. The delay may be impacted by an ability of a secondary user to gate off a scheduled resource use. A time t−T1 may be associated with the first O-CU/DU transmitting, to the O-RU, an indication of a resource use. A time T1 may be associated with an O-CU/DU to O-RU fronthaul delay. A time t may be associated with the O-RU receiving the indication of the resource use from the first O-CU/DU. Thus, an amount of time before the resource associated with the O-RU is able to be scheduled is T5.

As indicated above, FIGS. 7A-7B is provided as an example. Other examples may differ from what is described with regard to FIGS. 7A-7B.

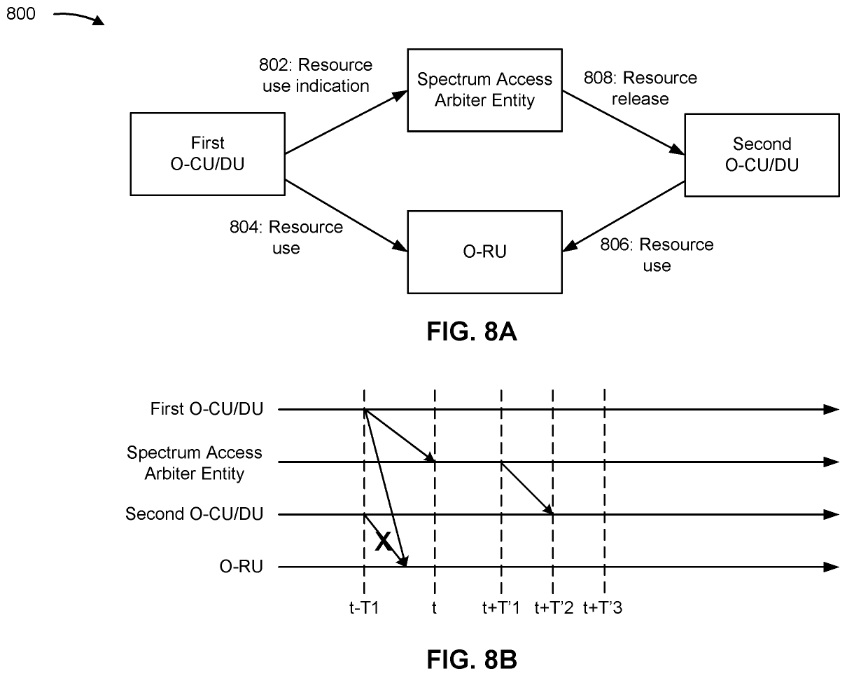

FIGS. 8A-8B are diagrams illustrating an example 800 associated with a spectrum access arbiter entity for sharing spectrum resources, in accordance with the present disclosure. As shown in FIGS. 8A-8B, example 800 includes communication between a spectrum access arbiter entity (e.g., spectrum access arbiter entity 112), an O-RU (e.g., O-RU 114), and multiple O-CUs/DUs (e.g., O-CU/DU 116), such as a first O-CU/DU and a second O-CU/DU. In some aspects, the spectrum access arbiter entity, the O-RU, and the multiple O-CUs/DUs may be included in a wireless network, such as wireless network 100.

As shown in FIG. 8A, and by reference number 802, the first O-CU/DU may transmit, to the spectrum access arbiter entity, an indication of a resource use, which may indicate that the first O-CU/DU is using resources associated with the O-RU. The O-RU may be a shared O-RU, which may be shared among the multiple O-CUs/DUs. As shown by reference number 804, the first O-CU/DU may transmit, to the O-RU, an indication of a resource use, which may indicate that the first O-CU/DU is using the resources associated with the O-RU. As shown by reference number 806, the second O-CU/DU may transmit, to the O-RU, an indication of a resource use, which may indicate that the second O-CU/DU is using resources associated with the O-RU. In other words, the first O-CU/DU and the second O-CU/DU may be attempting to use the same resources associated with the O-RU. As shown by reference number 808, the spectrum access arbiter entity may transmit, to the second O-CU/DU, an indication of a resource release, which may be based at least in part on the first O-CU/DU being a priority O-CU/DU and the second O-CU/DU being a secondary O-CU/DU. In other words, in this case, the first O-CU/DU may be granted access to use the resources associated with the O-RU, and the second O-CU/DU may be denied access to use the resources associated with the O-RU. The O-RU may determine that a checksum indicated in the indication of the resource use, as received from the first O-CU/DU, overrides a checksum indicated in the indication of the resource use, as received from the second O-CU/DU. In this case, the first O-CU/DU may preempt the second O-CU/DU for use of the resources associated with the O-RU, which may be based at least in part on the first O-CU/DU having the higher priority over the second O-CU/DU.

As shown in FIG. 8B, a time t−T1 may be associated with the first O-CU/DU transmitting, to the spectrum access arbiter entity, the indication of the resource use. The time t−T1 may also be associated with the first O-CU/DU transmitting, to the O-RU, the indication of the resource use. The time t−T1 may also be associated with the second O-CU/DU transmitting, to the O-RU, the indication of the resource use. A time T1 may be associated with an O-DU/CU to spectrum access arbiter entity delay. The time T1 may also be associated with an O-DU/CU processing and scheduling delay. A time t may be associated with the spectrum access arbiter entity receiving, from the first O-CU/DU, the indication of the resource use. A time T′1 may be associated with a spectrum access arbiter entity processing delay. A time t+T′1 may be associated with the spectrum access arbiter entity transmitting, to the second O-CU/DU, the indication of the resource release. A time t+T′2 may be associated with the second O-CU/DU receiving, from the spectrum access arbiter entity, the indication of the resource release. A time T′2−T′1 may be associated with a spectrum access arbiter entity to O-CU/DU fronthaul delay. A time T′3−T′2 may be associated with an O-DU processing delay. Thus, an amount of time before a secondary user is notified that the resources associated with the O-RU are unavailable is T1+T′3.

As indicated above, FIG. 8A-8B is provided as an example. Other examples may differ from what is described with regard to FIG. 8A-8B.

FIG. 9 is a diagram illustrating an example process 900 performed, for example, by a network node, in accordance with the present disclosure. Example process 900 is an example where the network node (e.g., network node 110) performs operations associated with a spectrum access arbiter entity for sharing spectrum resources.

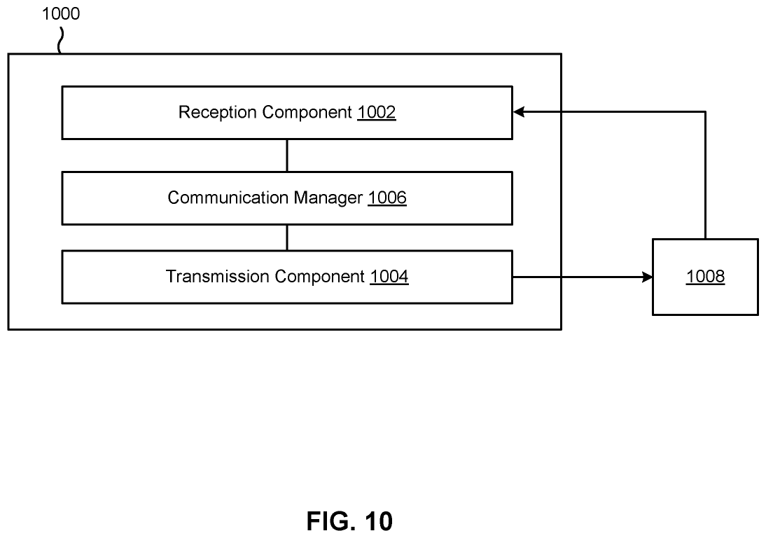

As shown in FIG. 9, in some aspects, process 900 may include transmitting, by a spectrum access arbiter entity associated with the network node and to an O-DU associated with the network node, a grant that permits use of a shared spectrum resource, the grant being associated with a reservation of the shared spectrum resource, and the grant indicating a first cryptographic checksum for a given timeslot in which the shared spectrum resource is granted (block 910). For example, the network node (e.g., using transmission component 1004 and/or communication manager 1006, depicted in FIG. 10) may transmit, by a spectrum access arbiter entity associated with the network node and to an O-DU associated with the network node, a grant that permits use of a shared spectrum resource, the grant being associated with a reservation of the shared spectrum resource, and the grant indicating a first cryptographic checksum for a given timeslot in which the shared spectrum resource is granted, as described above, for example, with reference to FIGS. 4, 5, 6A, 6B, 7A, 7B, 8A, 8B, 9, and/or 10. In some aspects, the grant may be part of a reservation response, and may be transmitted in response to a reservation request. The grant may indicate the first cryptographic checksum, which may be previously determined and stored based at least in part on a secret key exchange.

As further shown in FIG. 9, in some aspects, process 900 may include receiving, by an O-RU associated with the network node and from the O-DU, a transmission that includes a second cryptographic checksum, the transmission being received based at least in part on the grant (block 920). For example, the network node (e.g., using reception component 1002 and/or communication manager 1006, depicted in FIG. 10) may receive, by an O-RU associated with the network node and from the O-DU, a transmission that includes a second cryptographic checksum, the transmission being received based at least in part on the grant, as described above, for example, with reference to FIGS. 4, 5, 6A, 6B, 7A, 7B, 8A, 8B, 9, and/or 10. In some aspects, based at least in part on the reservation response, the transmission including the second cryptographic checksum may be transmitted.

As further shown in FIG. 9, in some aspects, process 900 may include transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum (block 930). For example, the network node (e.g., using transmission component 1004 and/or communication manager 1006, depicted in FIG. 10) may transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum, as described above, for example, with reference to FIGS. 4, 5, 6A, 6B, 7A, 7B, 8A, 8B, 9, and/or 10. In some aspects, the authentication may involve checking whether the second cryptographic checksum matches with the first cryptographic checksum, which may ensure that the transmission is permitted to use the shared spectrum resource. The first cryptographic checksum and the second cryptographic checksum may be the same when the same cryptographic checksum indicated in the grant is also indicated with the transmission. When the second cryptographic checksum does not match the first cryptographic checksum, the transmission may not be allowed to use the shared spectrum resource.

Process 900 may include additional aspects, such as any single aspect or any combination of aspects described below and/or in connection with one or more other processes described elsewhere herein.

In a first aspect, the spectrum access arbiter entity is co-located with the O-RU.

In a second aspect, alone or in combination with the first aspect, the spectrum access arbiter entity is non-co-located with the O-RU.

In a third aspect, alone or in combination with one or more of the first and second aspects, the spectrum access arbiter entity is associated with O-RU spectrum sharing.

In a fourth aspect, alone or in combination with one or more of the first through third aspects, the first cryptographic checksum is based at least in part on a secret key exchange between the O-RU and the spectrum access arbiter entity.

In a fifth aspect, alone or in combination with one or more of the first through fourth aspects, the transmission that includes the second cryptographic checksum is associated with IQ samples.

In a sixth aspect, alone or in combination with one or more of the first through fifth aspects, the O-DU is a first O-DU, wherein the first O-DU is a prioritized O-DU, and a second O-DU is a secondary O-DU.

In a seventh aspect, alone or in combination with one or more of the first through sixth aspects, the grant that permits the use of the shared spectrum resource is indicated in a reservation response, and the reservation response is based at least in part on a reservation request from the O-DU.

In an eighth aspect, alone or in combination with one or more of the first through seventh aspects, the O-RU is a shared O-RU among multiple mobile network operators.

In a ninth aspect, alone or in combination with one or more of the first through eighth aspects, the spectrum access arbiter entity is one of a plurality of spectrum access arbiter entities associated with the O-RU, and each spectrum access arbiter entity is associated with a subset of resources of the O-RU.

In a tenth aspect, alone or in combination with one or more of the first through ninth aspects, the grant is transmitted to the O-DU based at least in part on a conflict resulting from multiple O-DUs requesting same resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-5, 6A, 6B, 7A, 7B, 8A, and 8B. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may transmit a grant that permits use of a shared spectrum resource, the grant being associated with a reservation of the shared spectrum resource, and the grant indicating a first cryptographic checksum for a given timeslot in which the shared spectrum resource is granted. The communication manager 1006 may receive a transmission that includes a second cryptographic checksum, the transmission being received based at least in part on the grant. The transmission component 1004 may transmit the transmission via the shared spectrum resource based at least in part on an authentication of the transmission, the authentication based at least in part on a verification that the second cryptographic checksum corresponds to the first cryptographic checksum.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: transmitting, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted; receiving, by an open radio access network radio unit (O-RU) associated with the network node and from the O-DU, a transmission that includes a second cryptographic checksum, the transmission being received based at least in part on the grant; and transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

Aspect 2: The method of Aspect 1, wherein the spectrum access arbiter entity is co-located with the O-RU.

Aspect 3: The method of any of Aspects 1-2, wherein the spectrum access arbiter entity is non-co-located with the O-RU.

Aspect 4: The method of any of Aspects 1-3, wherein the spectrum access arbiter entity is associated with O-RU spectrum sharing.

Aspect 5: The method of any of Aspects 1-4, wherein the first cryptographic checksum is based at least in part on a secret key exchange between the O-RU and the spectrum access arbiter entity.

Aspect 6: The method of any of Aspects 1-5, wherein the transmission that includes the second cryptographic checksum is associated with in-phase and quadrature (IQ) samples.

Aspect 7: The method of any of Aspects 1-6, wherein the O-DU is a first O-DU, wherein the first O-DU is a prioritized O-DU, and wherein a second O-DU is a secondary O-DU.

Aspect 8: The method of any of Aspects 1-7, wherein the grant that permits the use of the shared spectrum resource is indicated in a reservation response, and wherein the reservation response is based at least in part on a reservation request from the O-DU.

Aspect 9: The method of any of Aspects 1-8, wherein the O-RU is a shared O-RU among multiple mobile network operators.

Aspect 10: The method of any of Aspects 1-9, wherein the spectrum access arbiter entity is one of a plurality of spectrum access arbiter entities associated with the O-RU, and wherein each spectrum access arbiter entity is associated with a subset of resources of the O-RU.

Aspect 11: The method of any of Aspects 1-10, wherein the grant is transmitted to the O-DU based at least in part on a conflict resulting from multiple O-DUs requesting same resources.

Aspect 12: An apparatus for wireless communication at a device, comprising a processor; memory coupled with the processor; and instructions stored in the memory and executable by the processor to cause the apparatus to perform the method of one or more of Aspects 1-11.

Aspect 13: A device for wireless communication, comprising a memory and one or more processors coupled to the memory, the one or more processors configured to perform the method of one or more of Aspects 1-11.

Aspect 14: An apparatus for wireless communication, comprising at least one means for performing the method of one or more of Aspects 1-11.

Aspect 15: A non-transitory computer-readable medium storing code for wireless communication, the code comprising instructions executable by a processor to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
memory; and
one or more processors, coupled to the memory, configured to:
transmit, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted;
receive, by an open radio access network radio unit (O-RU) associated with the network node and from the O-DU, a transmission that includes a second cryptographic checksum, the transmission being received based at least in part on the grant; and
transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

2. The apparatus of claim 1, wherein the spectrum access arbiter entity is co-located with the O-RU.

3. The apparatus of claim 1, wherein the spectrum access arbiter entity is non-co-located with the O-RU.

4. The apparatus of claim 1, wherein the spectrum access arbiter entity is associated with O-RU spectrum sharing.

5. The apparatus of claim 1, wherein the first cryptographic checksum is based at least in part on a secret key exchange between the O-RU and the spectrum access arbiter entity.

6. The apparatus of claim 1, wherein the transmission that includes the second cryptographic checksum is associated with in-phase and quadrature (IQ) samples.

7. The apparatus of claim 1, wherein the O-DU is a first O-DU, wherein the first O-DU is a prioritized O-DU, and wherein a second O-DU is a secondary O-DU.

8. The apparatus of claim 1, wherein the grant that permits the use of the shared spectrum resource is indicated in a reservation response, and wherein the reservation response is based at least in part on a reservation request from the O-DU.

9. The apparatus of claim 1, wherein the O-RU is a shared O-RU among multiple mobile network operators.

10. The apparatus of claim 1, wherein the spectrum access arbiter entity is one of a plurality of spectrum access arbiter entities associated with the O-RU, and wherein each spectrum access arbiter entity is associated with a subset of resources of the O-RU.

11. The apparatus of claim 1, wherein the grant is transmitted to the O-DU based at least in part on a conflict resulting from multiple O-DUs requesting same resources.

12. A method of wireless communication performed by a network node, comprising:
transmitting, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted;
receiving, by an open radio access network radio unit (O-RU) associated with the network node and from the O-DU, a transmission that includes a second cryptographic checksum, the transmission being received based at least in part on the grant; and
transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

13. The method of claim 12, wherein the spectrum access arbiter entity is co-located with the O-RU.

14. The method of claim 12, wherein the spectrum access arbiter entity is non-co-located with the O-RU.

15. The method of claim 12, wherein the spectrum access arbiter entity is associated with O-RU spectrum sharing.

16. The method of claim 12, wherein the first cryptographic checksum is based at least in part on a secret key exchange between the O-RU and the spectrum access arbiter entity.

17. The method of claim 12, wherein the transmission that includes the second cryptographic checksum is associated with in-phase and quadrature (IQ) samples.

18. The method of claim 12, wherein the O-DU is a first O-DU, wherein the first O-DU is a prioritized O-DU, and wherein a second O-DU is a secondary O-DU.

19. The method of claim 12, wherein the grant that permits the use of the shared spectrum resource is indicated in a reservation response, and wherein the reservation response is based at least in part on a reservation request from the O-DU.

20. The method of claim 12, wherein the O-RU is a shared O-RU among multiple mobile network operators.

21. The method of claim 12, wherein the spectrum access arbiter entity is one of a plurality of spectrum access arbiter entities associated with the O-RU, and wherein each spectrum access arbiter entity is associated with a subset of resources of the O-RU.

22. The method of claim 12, wherein the grant is transmitted to the O-DU based at least in part on a conflict resulting from multiple O-DUs requesting same resources.

23. A non-transitory computer-readable medium storing a set of instructions for wireless communication, the set of instructions comprising:
one or more instructions that, when executed by one or more processors of a network node, cause the network node to:
transmit, by a spectrum access arbiter entity associated with the network node and to an open radio access network distributed unit (O-DU) associated with the network node, a grant that permits use of a shared spectrum resource, the grant being associated with a reservation of the shared spectrum resource, and the grant indicating a first cryptographic checksum for a given timeslot in which the shared spectrum resource is granted;
receive, by an open radio access network radio unit (O-RU) associated with the network node and from the O-DU, a transmission that includes a second cryptographic checksum, the transmission being received based at least in part on the grant; and
transmit, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

24. The non-transitory computer-readable medium of claim 23, wherein:
the spectrum access arbiter entity is co-located with the O-RU; or
the spectrum access arbiter entity is non-co-located with the O-RU.

25. The non-transitory computer-readable medium of claim 23, wherein:
the first cryptographic checksum is based at least in part on a secret key exchange between the O-RU and the spectrum access arbiter entity;
the transmission that includes the second cryptographic checksum is associated with in-phase and quadrature (IQ) samples; or
the O-DU is a first O-DU, the first O-DU is a prioritized O-DU, and a second O-DU is a secondary O-DU.

26. The non-transitory computer-readable medium of claim 23, wherein:
the grant that permits the use of the shared spectrum resource is indicated in a reservation response, and the reservation response is based at least in part on a reservation request from the O-DU;
the O-RU is a shared O-RU among multiple mobile network operators; or
the spectrum access arbiter entity is one of a plurality of spectrum access arbiter entities associated with the O-RU, and each spectrum access arbiter entity is associated with a subset of resources of the O-RU.

27. An apparatus for wireless communication, comprising:
means for transmitting, by a spectrum access arbiter entity associated with the apparatus and to an open radio access network distributed unit (O-DU) associated with the apparatus, a grant that permits use of a shared spectrum resource, the grant being associated with a reservation of the shared spectrum resource, and the grant indicating a first cryptographic checksum for a given timeslot in which the shared spectrum resource is granted;
means for receiving, by an open radio access network radio unit (O-RU) associated with the apparatus and from the O-DU, a transmission that includes a second cryptographic checksum, the transmission being received based at least in part on the grant; and
means for transmitting, by the O-RU, the transmission via the shared spectrum resource based at least in part on an authentication of the transmission, the authentication involving the grant being accepted by the O-RU based at least in part on a verification that the second cryptographic checksum corresponds to the first cryptographic checksum.

28. The apparatus of claim 27, wherein:
the spectrum access arbiter entity is co-located with the O-RU; or
the spectrum access arbiter entity is non-co-located with the O-RU.

29. The apparatus of claim 27, wherein:
the first cryptographic checksum is based at least in part on a secret key exchange between the O-RU and the spectrum access arbiter entity;
the transmission that includes the second cryptographic checksum is associated with in-phase and quadrature (IQ) samples; or
the O-DU is a first O-DU, the first O-DU is a prioritized O-DU, and a second O-DU is a secondary O-DU.

30. The apparatus of claim 27, wherein:
the grant that permits the use of the shared spectrum resource is indicated in a reservation response, and the reservation response is based at least in part on a reservation request from the O-DU;
the O-RU is a shared O-RU among multiple mobile network operators; or
the spectrum access arbiter entity is one of a plurality of spectrum access arbiter entities associated with the O-RU, and each spectrum access arbiter entity is associated with a subset of resources of the O-RU.
